(19) United States
(12) Patent Application Publication
(10) Pub. No.: US 2014/0379537 A1
(43) Pub. Date: Dec. 25, 2014

(54) OPTIMIZING GENERATION OF AGENCY DEBIT MEMOS

(71) Applicant: Amadeus S.A.S., Sophia Antipolis (FR)

(72) Inventors: Laure Canis, Nice (FR); Francois Avril, Nice (FR)

(21) Appl. No.: 13/926,136

(22) Filed: Jun. 25, 2013

(51) Int. Cl. G06Q 40/00

(52) U.S. Cl. CPC G06Q 40/12
USPC 705/30

(57) ABSTRACT

Methods, systems, and computer program products for determining an expected value of generating an agency debit memo and/or inquiry, scheduling a task of generating the memo and/or inquiry, and determining optimal operator staffing levels. An optimizer module determines if an agency debit memo should be generated based on a probability the memo will be disputed by a travel agency and the expected value of generating the memo, and whether an inquiry should be generated in response to the dispute. Tasks of generating agency debit memos and inquiries are ranked and scheduled based on benefit density to optimize the cumulative net return for a given operator staffing level. Data is collected on execution of the tasks and ultimate outcomes and used to determine operator efficiency and to update expected value parameters. Optimum staffing levels may be determined by performing virtual task scheduling for different staffing levels.

### TECHNICAL FIELD

The invention generally relates to computers and computer software, and in particular to methods, systems, and computer program products for determining an expected net value of an agency debit memo issued to a travel service provider.

### BACKGROUND

In the travel industry, airline tickets are often sold through an indirect seller, such as a travel agency. The travel agency will typically check for available flights that satisfy a customer's itinerary and, once matching flights are found, book the flights for the customer. As part of this booking process, the travel agency will collect payment from the customer for the tickets. To cover the airline's charges for providing transportation services, the travel agency will then provide a portion of the collected payment to the airline.

To ensure that indirect ticket sellers are selling tickets in compliance with restrictions and rules, tickets may occasionally be audited. An audit may verify whether the amounts of the fare, taxes, and commission match the restrictions and rules in place regarding the details of the sold ticket. If the audit indicates that the travel agency did not properly compensate the airline, the airline may be able to recover the shortfall from the travel agency. One recent estimate indicated that the airline industry generates approximately $600 billion in annual revenue worldwide. Thus, correcting even small discrepancies averaging 1%-5% across all tickets sold could result in recovery of between $6 and $30 billion in lost revenue.

A mechanism for recovering revenue from travel agencies is to generate an agency debit memo, which is issued from the airline to the travel agency. However, because the generation of each agency debit memo incurs a cost, it may not be financially wise to generate an agency debit memo for every discrepancy discovered during an audit. For example, if the process to generate an agency debit memo costs $5, it may not be advisable to generate an agency debit memo in an attempt to recover only a $1 discrepancy.

Conventional auditing systems fail to take into account an expected cost of generating agency debit memos to determine whether an agency debit memo should be generated. Moreover, the travel agency may dispute the agency debit memo, which may add additional uncertainty to the process of recovering revenue. The airline may or may not elect to challenge a dispute by generating an inquiry. If an inquiry is initiated, then the expected cost of generating an agency debit memo rises. Thus, with respect to auditing tickets sold by a travel agency, a certain number of decisions regarding agency memo management need to be made by the party conducting the audit, such as the airline or a Business Process Outsourcer (BPO) working on behalf of the airline

Typically, decisions regarding when to generate an agency debit memo and when to generate an inquiry in response to receiving a dispute are based on: (1) settings made on an ad-hoc basis by the airline without in-depth analysis; or (2) the number of human resources budgeted for manual interventions. As a result, decisions to: (1) ignore a discrepancy; (2) generate an agency debit memo; (3) take no action in response to receiving a dispute; and/or (4) generate an inquiry in response to receiving a dispute are left to operators, who select the next task to execute based on their own anecdotal experience. Decisions therefore tend to be somewhat inconsistent and can subjectively vary from operator to operator.

Thus, improved systems, methods, and computer program products for analyzing ticket audit results are needed that assist in managing ticket auditing to maximize operator utilization and net revenues recovered by the airlines from indirect sellers of airline tickets.

### SUMMARY

In an embodiment of the invention, a method of issuing an agency debit memo to a travel agency is provided. The method includes receiving data at a computer, the data relating to a ticket sold by the travel agency. The ticket may be audited at the computer based on the data to compare a first amount charged for the ticket with a second amount that is an audit amount for the ticket. In response to the second amount exceeding the first amount by a numerical discrepancy, an expected value of generating an agency debit memo is determined. The determination is based on a cost model in which an inquiry regarding an accuracy of the agency debit memo is not generated in response to a dispute of the agency debit memo by the travel agency. The method further includes, if the expected value is greater than a threshold value, generating the agency debit memo.

In another embodiment of the invention, an apparatus is provided that includes a processor and a memory. The memory includes instructions that, when executed by the processor, cause the apparatus to receive data relating to a ticket sold by the travel agency and audit the ticket based on the data to compare a first amount charged for the ticket with a second amount that is an audit amount for the ticket. In response to the second amount exceeding the first amount by a numerical discrepancy, the apparatus determines an expected value of generating an agency debit memo based on a cost model in which an inquiry regarding an accuracy of the agency debit memo is not generated in response to a dispute of the agency debit memo by the travel agency. If the expected value is greater than a threshold value, the instructions may further cause the apparatus to generate the agency debit memo.

In another embodiment of the invention, a computer program product is provided that includes a non-transitory computer readable storage medium including instructions. The instructions may be configured, when executed by a processor, to cause the processor to receive data relating to a ticket sold by the travel agency and audit the ticket based on the data to compare a first amount charged for the ticket with a second amount that is an audit amount for the ticket. In response to the second amount exceeding the first amount by a numerical discrepancy, the processor executing the instructions determines an expected value of generating an agency debit memo based on a cost model in which an inquiry regarding an accuracy of the agency debit memo is not generated in response to a dispute of the agency debit memo by the travel agency. The instructions may further cause the processor to generate the agency debit memo if the expected value is greater than a threshold value.

In another embodiment of the invention, a method of optimizing an auditing process for tickets issued by a travel agency is provided. The method includes receiving data relating to a first plurality of tickets sold by the travel agency at a computer. Each ticket of the first plurality of tickets is audited based on the data to compare a first amount charged for the ticket with a second amount that is an audit amount for the ticket. An expected value of generating an agency debit memo is determined for each ticket of the first plurality of tickets for which the second amount exceeds the first amount by a first threshold. A second plurality of tickets is selected from the first plurality of tickets based on the expected value of each of the selected tickets exceeding a second threshold. Agency debit memos are generated for the second plurality of tickets, and a percentage of the agency debit memos that are disputed by the travel agency is determined. The method determines a probability that the travel agency will not dispute an agency debit memo based at least in part on the percentage, and uses the probability to determine the expected value of generating an agency debit memo for additional tickets sold by the travel agency.

In another embodiment of the invention, an apparatus is provided that includes a processor and a memory. The memory includes instructions that, when executed by the processor, cause the apparatus to receive data relating to a first plurality of tickets sold by the travel agency and audit each ticket of the first plurality of tickets based on the data to compare a first amount charged for the ticket with a second amount that is an audit amount for the ticket. The apparatus determines an expected value of generating an agency debit memo for each ticket of the first plurality of tickets for which the second amount exceeds the first amount by a first threshold, and selects a second plurality of tickets from the first plurality of tickets based on the first expected value of each of the selected tickets exceeding a second threshold. The apparatus further generates the agency debit memos for the second plurality of tickets and determines a percentage of the agency debit memos that are disputed by the travel agency. The instructions may further cause the apparatus to determine a probability that the travel agency will not dispute an agency debit memo based at least in part on the percentage, and use the probability to determine the expected value of generating an agency debit memo for additional tickets sold by the travel agency.

In another embodiment of the invention, a computer program product is provided that includes a non-transitory computer readable storage medium including instructions. The instructions may be configured, when executed by a processor, to cause the processor to receive data relating to a first plurality of tickets sold by the travel agency and audit each ticket of the first plurality of tickets based on the data to compare a first amount charged for the ticket with a second amount that is an audit amount for the ticket. The processor executing the instructions determines an expected value of generating an agency debit memo for each ticket of the first plurality of tickets for which the second amount exceeds the first amount by a first threshold, and selects a second plurality of tickets from the first plurality of tickets based on the expected value of each of the selected tickets exceeding a second threshold. The processor executing the instructions further generates the agency debit memos for the second plurality of tickets and determines a percentage of the agency debit memos that are disputed by the travel agency. The instructions may further cause the processor to determine a probability that the travel agency will not dispute an agency debit memo based at least in part on the percentage, and use the probability to determine the expected value of generating an agency debit memo for additional tickets sold by the travel agency.

In another embodiment of the invention, a method of scheduling tasks is provided. The method includes receiving data relating to a plurality of audited tickets at a computer, each of the tickets having been determined to have a discrepancy between a first amount charged for the ticket and a second amount that is an audit amount for the ticket. The method determines an expected benefit density value for each of a plurality of tasks, each task being directed to generating an agency debit memo for a ticket of the plurality of tickets. Each task of the plurality of tasks is ranked based on the expected benefit density value of the task in order of decreasing value. A target time period is determined for each task of the plurality of tasks, the target time period defining a time period during which it is desired that the task be executed. Each task of the plurality of tasks is scheduled in the target time period for that task if sufficient resources are available to execute the task during the target time period. The tasks are thereby scheduled in the ranked order so that tasks having the highest expected benefit density value are scheduled first. If the task cannot be scheduled in the target time period due to a lack of resources, the method attempts to schedule the task in progressively earlier time periods until either the task is scheduled or no more time periods are available.

In another embodiment of the invention, an apparatus is provided that includes a processor and a memory. The memory includes instructions that, when executed by the processor, cause the apparatus to receive data relating to a plurality of audited tickets, each of the tickets having been determined to have a discrepancy between a first amount charged for the ticket and a second amount that is an audit amount for the ticket. An expected benefit density value is determined for each of a plurality of tasks, each task directed to generating an agency debit memo for a ticket of the plurality of tickets. The apparatus ranks each task of the plurality of tasks based on the expected benefit density value of the task in order of decreasing value and determines a target time period for each task of the plurality of tasks, the target time period defining a time period during which it is desired that the task be executed. Each task of the plurality of tasks is scheduled in the target time period for that task if sufficient resources are available to execute the task during the target time period. The tasks are thereby scheduled in the ranked order so that tasks having the highest expected benefit density value are scheduled first. If the task cannot be scheduled in the target time period due to a lack of resources, the apparatus attempts to schedule the task in progressively earlier time periods until either the task is scheduled or no more time periods are available.

In another embodiment of the invention, a computer program product is provided that includes a non-transitory computer readable storage medium including instructions. The instructions may be configured, when executed by a processor, to cause the processor to receive data relating to a plurality of audited tickets, each of the tickets having been determined to have a discrepancy between a first amount charged for the ticket and a second amount that is an audit amount for the ticket. An expected benefit density value is determined for each of a plurality of tasks, each task directed to generating an agency debit memo for a ticket of the plurality of tickets. The processor executing the instructions ranks each task of the plurality of tasks based on the expected benefit density value of the task in order of decreasing value and determines a target time period for each task of the plurality of tasks, the target time period defining a time period during which it is desired that the task be executed. Each task of the plurality of tasks is scheduled in the target time period for that task if sufficient resources are available to execute the task during the target time period. The tasks are thereby scheduled in the ranked order so that tasks having the highest expected benefit density value are scheduled first. If the task cannot be scheduled in the target time period due to a lack of resources, the processor executing the instructions attempts to schedule the task in progressively earlier time periods until either the task is scheduled or no more time periods are available.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an exemplary operating environment including a plurality of computer systems in communication via a network.

FIG. 2 is a diagrammatic view of an exemplary computer system of FIG. 1.

FIG. 3 is a diagrammatic view of a block diagram depicting an audit process management system that may be hosted by one or more of the computer systems in FIG. 1.

FIG. 4 is a flow chart depicting an audit process that may be executed by the audit process management system of FIG. 3.

FIG. 5 is a flow chart depicting a task value estimating process that may be executed by the audit process management system of FIG. 3.

FIG. 6 is a flow chart depicting a task scheduling process that may be executed by the audit process management system of FIG. 3.

FIG. 7 is a flow chart depicting a task assignment process that may be executed by the audit process management system of FIG. 3.

FIG. 8 is a flow chart depicting a process for estimating an optimal level of operator resources that may be executed by the audit process management system of FIG. 3.

FIG. 9 is a graphical view of an expected cumulative return for varying operator staffing levels based on a plurality of agency debit memo dispute rates.

### DETAILED DESCRIPTION

Embodiments of the invention may be implemented by a processing and database system, such as a Global Distribution System (GDS). The processing and database system may facilitate interconnections between indirect sellers of airline tickets and a plurality of computer reservation systems each associated with a travel service provider. In the context of air travel, the processing and database system may be configured allow travelers to book airline tickets through indirect sales channels, such as travel agencies. The travel agencies may then receive payment from the travelers for the booked tickets and compensate the airlines. To determine if the airline is being properly compensated, the processing and database system may include an auditing module that determines an audit amount representing a fare that should have been charged for the ticket based on data relating to the ticket. For example, the auditing module may check that fare tariffs, business rules, routing maps, class of service tables, tax information, etc. were properly implemented by the travel agency to determine the cost of the ticket. Business rules may include booking conditions such as minimum stay or advance purchase, and may be specific to a city pair and/or a class of service.

The auditing module may then compare the actual fare charged by the travel agency to a fare that should have been charged for the ticket, i.e., the audit amount. If a numerical discrepancy exists between the amount charged for the ticket the audit amount, a memo management optimizer module may determine an expected value of generating an agency debit memo to recover the numerical discrepancy from the travel agency. The expected value may be determined taking into account one or more of the numerical discrepancy, a cost of generating the memo, a probability that the audit is accurate, a probability that the agency will dispute the agency debit memo, and a cost of generating an inquiry in response to the agency debit memo being disputed. Historical data may be collected by a data collection module regarding results from generating agency debit memos. This data may be used to adjust parameters used by the memo management optimizer module to determine the expected value of generating agency debit memos and dispute inquiries. Exemplary parameters may include dispute probabilities, audit accuracy, numerical discrepancies, the cost of generating the agency debit memo, and the cost of generating the inquiry. The memo management optimizer module may also analyze existing operator staffing levels and schedule tasks for generating agency debit memos and/or inquiries in a manner that optimizes revenue recovery based on available operator resources. An operator value estimator module may further determine optimal operator staffing levels based on the value of tasks that expire without being executed due to a lack of resources. The operator value estimator may thereby help system managers make informed decisions regarding staffing levels.

The memo management optimizer module may thereby improve the ticket auditing process by facilitating improve decisions regarding: (1) when to generate an agency debit memo; (2) when to generate an inquiry in response the agency debit memo being disputed; and (3) the amount of human resources that should be provided for performing the audit and revenue recovery activities. The information provided by the memo management optimizer may thereby facilitate improved decision making with regard to the audit process so as to maximize net value of revenues recovered.

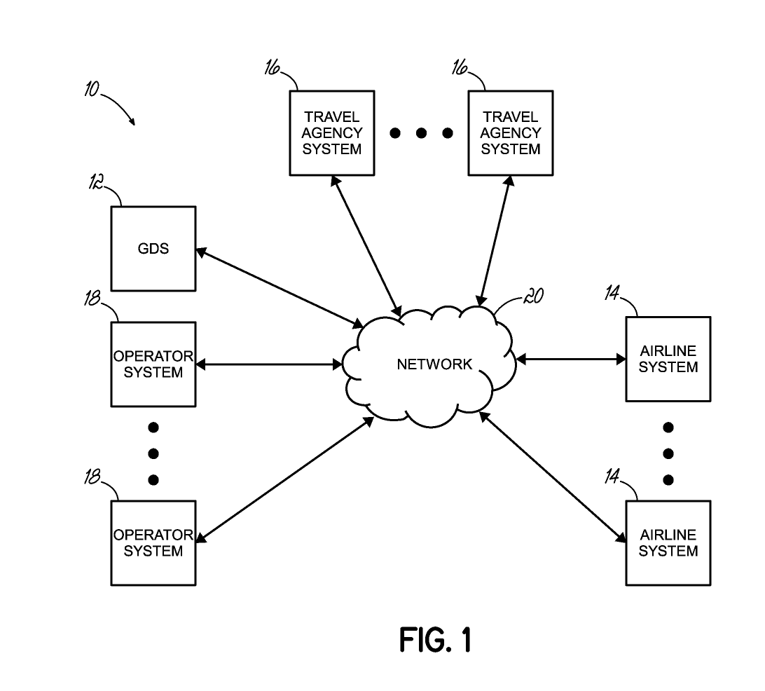

Referring now to FIG. 1, an operating environment 10 in accordance with an embodiment of the invention may include a Global Distribution System (GDS) 12, one or more airline systems 14, one or more travel agency systems 16, and one or more operator terminals 18 that are in communication, either directly and/or via a network 20. The airline systems 14 may each include a Computer Reservation System (CRS) and/or billing system for the respective airline that enables the travel agency systems 16 and/or GDS 12 to reserve and pay for airline tickets. The network 20 may include one or more private and/or public networks (e.g., the Internet) that enable the exchange of data.

The GDS 12 may be configured to facilitate communication between the airline systems 14 and travel agency systems 16 by enabling travel agents to book reservations on one or more airline systems 14 via the GDS 12. To this end, the GDS 12 may maintain links to each of the airline systems 14 via the network 20. These links may allow the GDS 12 to route reservation requests from the travel agency systems 16 to the corresponding airline system 14. The travel agent systems 16 may thereby book flights on multiple airlines via a single connection to the GDS 12. The GDS 12 may also store copies of Passenger Name Records (PNRs) generated by the airline systems 14. These copies may allow a PNR to be maintained by the GDS 12 that includes a complete set of flight data for an itinerary including air segments from multiple airlines.

The operator systems 18 may be in communication with the GDS 12 via the network 20 or some other suitable connection, and may provide system operators with a terminal or other suitable interface to the GDS 12. Operators may thereby communicate with the GDS 12 via the operator systems 18 and execute tasks that include tasks relating to the auditing of tickets sold by the travel agencies. To this end, modules hosted by the GDS 12 and/or other computer systems comprising the operating environment 10 may provide tasks to each operator system 18 for display to the operator. Each operator system 18 may also accept input from the operator to enable the operator to select and cause the displayed tasks to be executed by their respective systems.

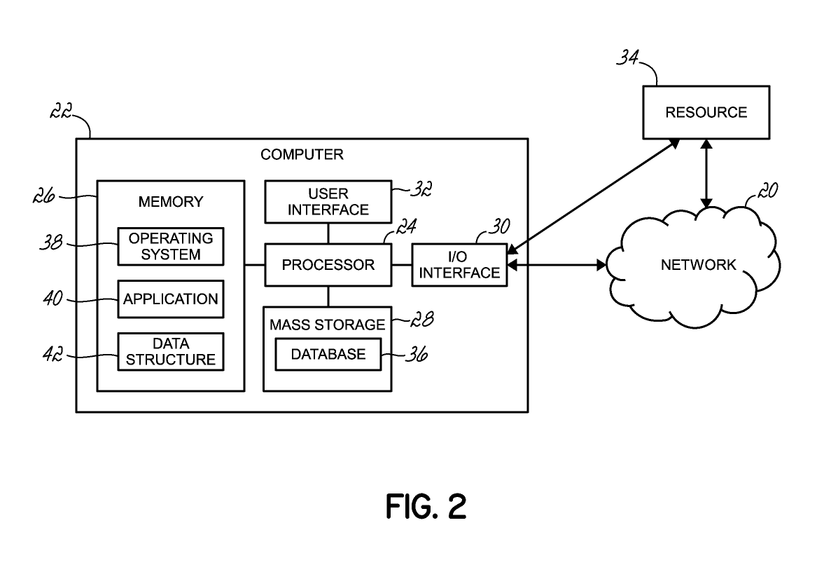

Referring now to FIG. 2, the GDS 12, airline systems 14, travel agency systems 16, and operator systems 18 of operating environment 10 may be implemented on one or more computer devices or systems, such as exemplary computer system 22. The computer system 22 may include a processor 24, a memory 26, a mass storage memory device 28, an input/output (I/O) interface 30, and a user interface 32. The computer system 22 may also be operatively coupled to one or more external resources 34 via the network 20 and/or I/O interface 30.

The processor 24 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 26. Memory 26 may include a single memory device or a plurality of memory devices including but not limited to read-only memory (ROM), random access memory (RAM), volatile memory, non-volatile memory, static random access memory (SRAM), dynamic random access memory (DRAM), flash memory, cache memory, or any other device capable of storing information. The mass storage memory device 28 may include data storage devices such as a hard drive, optical drive, tape drive, non-volatile solid state device, or any other device capable of storing information. A database 36 may reside on the mass storage memory device 28, and may be used to collect and organize data used by the various systems and modules described herein.

Processor 24 may operate under the control of an operating system 38 that resides in memory 26. The operating system 38 may manage computer resources so that computer program code embodied as one or more computer software applications, such as application 40 residing in memory 26 may have instructions executed by the processor 24. In an alternative embodiment, the processor 24 may execute the applications 40 directly, in which case the operating system 38 may be omitted. One or more data structures 42 may also reside in memory 26, and may be used by the processor 24, operating system 38, and/or application 40 to store or manipulate data.

The I/O interface 30 may provide a machine interface that operatively couples the processor 24 to other devices and systems, such as the network 20 and/or external resource 34. The application 40 may thereby work cooperatively with the network 20 and/or external resource 34 by communicating via the I/O interface 30 to provide the various features, functions, and/or modules comprising embodiments of the invention. The application 40 may also have program code that is executed by one or more external resources 34, or otherwise rely on functions and/or signals provided by other system or network components external to the computer system 22. Indeed, given the nearly endless hardware and software configurations possible, persons having ordinary skill in the art will understand that embodiments of the invention may include applications that are located externally to the computer system 22, distributed among multiple computers or other external resources 34, or provided by computing resources (hardware and software) that are provided as a service over the network 20, such as a cloud computing service.

The user interface 32 may be operatively coupled to the processor 24 of computer system 22 in a known manner to allow a user to interact directly with the computer system 22. The user interface 32 may include video and/or alphanumeric displays, a touch screen, a speaker, and any other suitable audio and visual indicators capable of providing information to the user. The user interface 32 may also include input devices and controls such as an alphanumeric keyboard, a pointing device, keypads, pushbuttons, control knobs, microphones, etc., capable of accepting commands or input from the user and transmitting the entered input to the processor 24.

An airline ticket purchased through one of the travel agency systems 16 may involve booking, pricing, and ticketing the flight. Booking the flight may include checking an airline inventory for availability of the flight. This check may include sending a booking request from the travel agency system 16 to the GDS 12, which may in turn query a corresponding airline system 14 for flight availability. If a seat is available for the requested flight, the flight may be booked and the airline inventory decreased to reflect the booking. The flight may then be priced by the travel agency with the help of a fare engine, and the traveler's account billed accordingly. The ticketing process may include the travel agency reporting the sale of the ticket to the airline's Billing and Settlement Plan (BSP) in the name of the airline. In the United States, the Airline Reporting Corporation (ARC) normally provides this service. In any case, the BSP may act as a Business Process Outsourcer (BPO) that provides a clearing house which settles accounts between the travel agency and the validating airline. The airline may thereby collect a fare via the BSP for providing the airline seat.

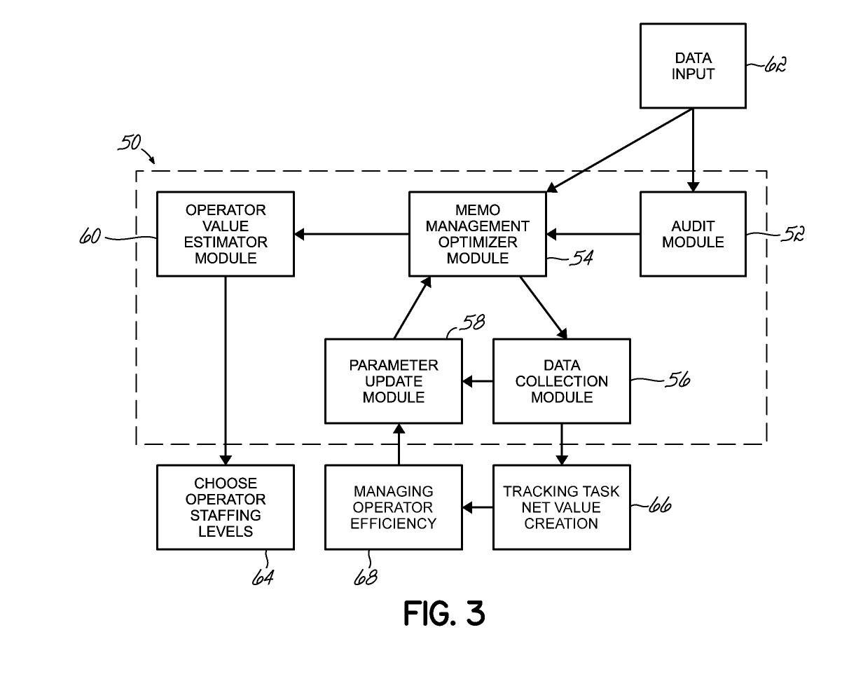

Referring now to FIG. 3, an audit process management system 50 may include an audit module 52, a memo management optimizer module 54, a data collection module 56, a parameter update module 58, and an operator value estimator module 60. The audit process management system 50 may be configured to receive ticket data input 62 from one or more sources. The data input 62 may be received from any suitable source of data, such as the GDS 12, the airline system 14, the travel agency system 16, and/or the operator system 18. Thus, data input 62 may originate from a computer system, database, and/or network, and may include data entered by a system operator. The data input 62 may include data regarding ticket fares, ticket tariffs, ticket taxes, costs relating to generation of agency debit memos, costs relating to generating an inquiry regarding the accuracy of a disputed agency debit memo, and probabilities for different outcomes resulting from generation of an agency debit memo or inquiry. The received data may include data relating to a ticket sold by one of a plurality of travel agencies, cost parameters for generating agency debit memos and inquiries, probabilities that agency debit memos will be disputed, and probabilities that an audit amounts are accurate. The audit process management system 50 may also output empirical data regarding observed probabilities, memo and inquiry generation costs, operator efficiency, and the net cumulative values generated by operators. This output data may be used to help choose operator staffing levels 64, for tracking task net value creation 66, and/or managing operator efficiency 68, as described in more detail below.

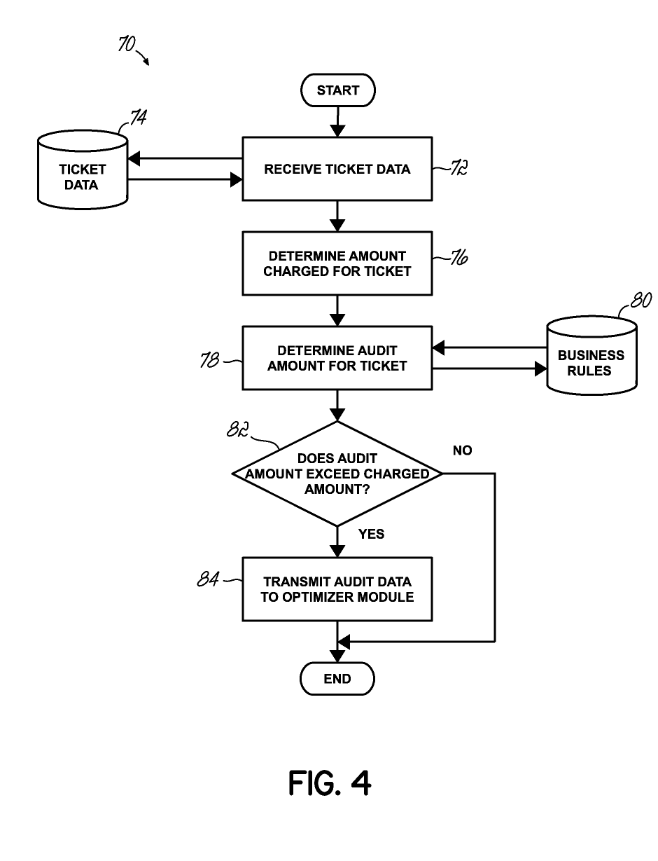

Referring now to FIG. 4, a flow chart is presented that depicts an audit process 70 that may be executed by the audit module 52 to determine if the travel agency properly charged for a ticket. In block 72, the audit module 52 may receive data regarding the ticket sold by the travel agency. The data may be automatically received in a push or may be received in response to a query by the audit module 52 to a ticket database 74. For example, the ticket data may be received from one or more of the GDS 12, the airline system 14 (e.g., from an E-ticket server), the travel agency system 16, the BSP, or any other suitable source.

In block 76, the audit module 52 may determine an amount that was charged for the ticket by the travel agency. This determination may be based on the ticket data received in block 72. In block 78, the audit module 52 may determine an audit amount for the ticket. The audit amount may reflect an amount that should have been charged for the ticket based on business rules. These business rules may be received by the audit module 52 from a business rules database 80, which may be hosted by the GDS 12 and/or the airline system 14.

In response to determining the audit amount, the audit module 52 may proceed to block 82 in which the charged amount is compared with to the audit amount to determine if there is a numerical discrepancy V between the two amounts. In response to there being a positive numerical discrepancy V resulting from the audit amount exceeding the charged amount (“YES” branch of decision block 82), the audit module 52 may proceed to block 84 and transmit data to the optimizer module 54 indicative of the value of the numerical discrepancy V. In an alternative embodiment of the invention, the audit module 52 may require that the numerical discrepancy V exceed a threshold amount to trigger transmission of the audit data to the optimizer module 54. This threshold may be selected so that only tickets having a numerical discrepancy V sufficient to generate a positive net return are forwarded to the optimizer module 54. In any case, if the audit amount does not exceed the charged amount (“NO” branch of decision block 82), the audit module 52 may determine that a sufficient amount was charged for the ticket by the travel agency and end the audit process 70.

The optimizer module 54 may be configured to determine an expected value of generating an agency debit memo based on one or more cost models. The cost model used to determine the expected value may be selected based on an assumption regarding whether the travel agency will dispute the memo and/or the value of the numerical discrepancy V for the audited ticket. The selected cost model may determine the expected value based on probabilities regarding whether the travel agency will dispute the agency debit memo, the accuracy of the audit module 52, as well as memo and inquiry generation costs. The optimizer module 54 may also schedule tasks related to generating the agency debit memo and/or an inquiry based on deadlines for generating agency debit memos and inquiries, operator staffing levels, and/or the expected value of generating the agency debit memo and/or inquiry.

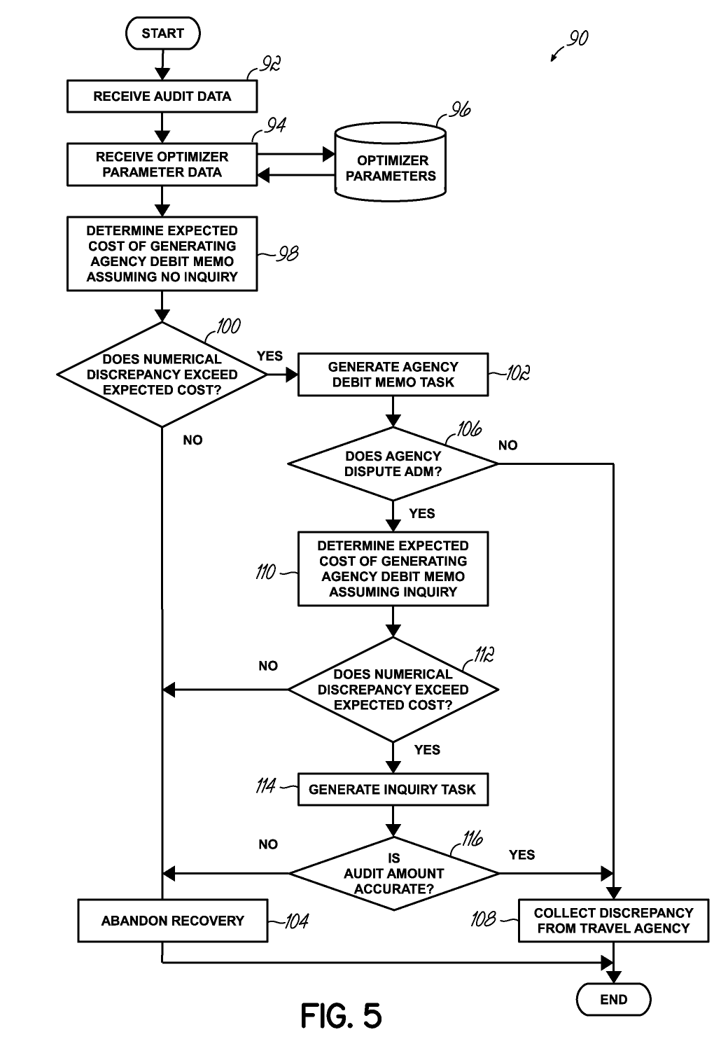

Referring now to FIG. 5, a flow chart depicts a task value estimating process 90 which may be performed by the optimizer module 54 in accordance with an embodiment of the invention. In block 92, the optimizer module 54 may receive audit data from the audit module 52. In response to receiving the audit data, the optimizer module 54 may proceed to block 94. In block 94, the optimizer module 54 may receive optimizer parameter data. This optimizer parameter data may be received, for example, from a database of optimizer parameters 96, and may include: (1) an estimated cost G of generating the agency debit memo; (2) an estimated cost D of generating an inquiry in response to the agency debit memo being disputed by the travel agency; (3) data indicative of an accuracy A of an auditing engine used by the audit module 52 (i.e., the probability that an audit amount determined by the audit module is correct); (4) a probability P_{R} that the travel agency will dispute an agency debit memo generated based on an accurate audit amount; and (5) a probability P_{W} that the travel agency will dispute an agency debit memo issued based on an inaccurate audit amount. In an embodiment of the invention, the optimizer parameters may be relatively static, so that the optimizer parameters do not need to be received each time audit data is received. Thus, the optimizer parameter data may be stored and reused by the optimizer module 54 to determine the expected value of generating an agency debit memo for a plurality of audited tickets.

The probabilities P_{R}, P_{W} may be specific to the travel agency that issued the ticket, or may be probabilities that generally describe the likelihood that a travel agency will dispute an agency debit memo. The probability that the travel agency will dispute the agency debit memo may depend on whether the agency debit memo is accurate. For example, the travel agency may be more likely to dispute the agency debit memo if the memo was generated based on erroneous audit data. Thus, the probabilities P_{R}, P_{W} may be determined individually. In any case, the optimizer parameter data may be stored and accessed locally or remotely, and may be received by the optimizer module 54 periodically (e.g., once a day) and/or when triggered by an event such as a parameter database update. The accuracy A and the probabilities P_{R}, and P_{W} may have values between 0 (always wrong/never occurs) and 1 (always correct/always occurs). The probability that the auditing engine is incorrect may therefore equal (1−A), the probability that the travel agency will not dispute an accurate agency debit memo may equal (1−P_{R}), and the probability that the travel agency will not dispute an inaccurate agency debit memo may equal (1−P_{W}).

In block 98, the optimizer module 54 may determine an expected cost of generating an agency debit memo for the audited ticket. This expected cost may be based on a cost model that assumes an inquiry will not be generated in response to the agency debit memo being disputed. To determine the expected cost under this cost model, the optimizer module 54 may determine: (1) a probability (A×P_{R}) that the agency debit memo is accurate (e.g., based on an accurate audit amount) and that the travel agency will dispute the accurate agency debit memo; (2) a probability (A×(1−P_{R})) that the agency debit memo is accurate and the travel agency will not dispute the accurate agency debit memo; (3) a probability ((1−A)×P_{W}) that the agency debit memo is inaccurate (e.g., based on an inaccurate audit amount) and the travel agency will dispute the inaccurate agency debit memo; and (4) a probability ((1−A)×(1−P_{W})) that the agency debit memo is inaccurate and the travel agency will not dispute the inaccurate agency debit memo. In an embodiment of the invention, these probabilities may be determined at a system level and used by the optimizer module 54 for the plurality of audited tickets.

Based on the above probability and cost data, the optimizer module 54 may determine the expected cost of generating the agency debit memo based on the cost model that assumes no inquiry will be made. The expected cost C₀ for this cost model may be provided by:

$${C}_{0} = \frac{G}{1 - ( A \times {P}_{R} + ( 1 - A ) \times {P}_{W} )} \qquad ( Equation 1 )$$

in which the denominator 1−(A×P_{R}+(1−A)×P_{W}) represents a total probability that the travel agency will not dispute the agency debit memo. That is, the denominator may represent unity minus the sum of the probabilities that (1) the agency debit memo is accurate and will be disputed (A×P_{R}), and (2) the agency debit memo is inaccurate and will be disputed ((1−A)×P_{W}).

In block 100, the optimizer module 54 may determine if the numerical discrepancy V exceeds the expected memo generation cost C₀. If the numerical discrepancy V exceeds the expected cost C₀ (“YES” branch of decision block 100), thereby indicating that the expected value of generating the agency debit memo is positive, the optimizer module 54 may proceed to block 102. If the numerical discrepancy V does not exceed the expected cost C₀ (“No” branch of decision block 100), thereby indicating that the expected value of generating the agency debit memo is either negative or zero, the optimizer module 54 may proceed to block 104, causing the effort to recover the numerical discrepancy V to be abandoned. In an alternative embodiment of the invention, the optimizer module 54 may require that the expected value (V−Cₒ) of generating the agency debit memo exceed a minimum threshold value (e.g., $1) to avoid abandoning the recovery effort.

In block 102, the optimizer module 54 may generate an agency debit memo task. The agency debit memo task may be stored in an unscheduled task list that contains tasks waiting to be scheduled and/or assigned to an operator. The task may be configured to provide an operator with instructions to generate the agency debit memo for the audited ticket. In an alternative embodiment of the invention, the audit process management system 50 may be configured to execute tasks stored in the unscheduled task list automatically so that the agency debit memo is generated without the need for an operator to execute the task.

In block 106, the optimizer module 54 may determine recommended responses that depend on whether the travel agency disputes the agency debit memo. These response decisions may be “predetermined” (i.e., made prior to receiving a dispute from the travel agency) based at least in part on the value of the numerical discrepancy V or may be made in response to receiving a dispute. In response to the travel agency failing to dispute the agency debit memo (“NO” branch of decision block 106), the optimizer module 54 may proceed to block 108 and cause the numerical discrepancy to be recovered from the travel agency. If, on the other hand, the travel agency disputes the agency debit memo (“YES” branch of decision block 106), the optimizer module 54 may proceed to block 110.

In block 110, the optimizer module 54 may determine an expected cost based on a cost model that assumes an inquiry will be made if the agency debit memo is disputed. This expected cost C₁ may be provided by the following equation:

$${C}_{1} = D \times \frac{A \times {P}_{R} + ( 1 - A ) \times {P}_{W}}{A \times {P}_{R}} \qquad ( Equation 2 )$$

where the numerator A×P_{R}+(1−A)×P_{W} represents a total probability that the travel agency will dispute the agency debit memo. That is, the numerator may represent the sum of the probability that the agency debit memo is accurate and will be disputed A×P_{R}, and the probability that the agency debit memo is inaccurate and will be disputed (1−A)×P_{W}.

In block 112, the optimizer module 54 may determine if the numerical discrepancy V exceeds the expected cost of the inquiry C₁. Because the cost G of generating the agency debit memo is a sunk cost at the time the dispute is received, G may not factor into the decision on whether or not to generate an inquiry. Rather, the decision may be made based solely on the potential recovery V and the expected cost C₁ of generating the inquiry. Thus, in response to the numerical discrepancy V exceeding C₁ (“YES” branch of decision block 112), the optimizer module 54 may proceed to block 114 and generate an inquiry task, or in the case the inquiry has yet to be received, set an inquiry flag before proceeding to block 116. The inquiry flag may be configured to cause the optimizer module 54 to generate the inquiry task in response to receiving a dispute from the travel agency at a later time.

Similarly to the agency debit memo task, the inquiry task may provide instructions for an operator to generate the inquiry. The optimizer module 54 may be configured to make the determination on generating the inquiry at the time the agency debit memo is generated, in response to receiving the dispute from the travel agency, or at any other suitable time between the time the audit data is received and generation of the inquiry. Inquiry tasks may be added to the unscheduled task list so that they may be scheduled along with agency debit memo tasks, as described in more detail below. If the numerical discrepancy V does not exceed C₁ by a sufficient amount (“NO” branch of decision block 112), then the optimizer module 54 may proceed to block 104 and cause the recovery process to be abandoned.

If the result of the inquiry is that the audit amount is accurate (“YES” branch of decision block 116), the optimizer module 54 may proceed to block 108 and cause the numerical discrepancy is recovered from the travel agency. If the result of the inquiry is that the audit amount was in error (“NO” branch of decision block 116), the optimizer module 54 may proceed to block 104 and cause the recovery process to be abandoned.

Equations 1 and 2 may provide optimal decision thresholds, and may be based on probabilities that one of a limited number of possible outcomes will result from generation of an agency debit memo. For example, one possible set of outcomes resulting from generating an agency debit memo includes four possibilities, or scenarios. Each scenario defines a possible outcome that may depend on conditions that are unknown at the time the memo is generated. To address these unknown conditions, decision thresholds may be set using probabilities.

Scenario 1: The agency debit memo is accurate and the travel agency disputes the memo. As described above, the probability of this scenario may be (A×P_{R}). The net revenue produced under this scenario may depend on whether an inquiry is generated, which in turn may depend on whether the numerical discrepancy V is sufficiently large to trigger an inquiry in response to receiving the dispute. That is, if V is greater than C₁, the inquiry may be generated, and if V is not greater than C₁, the inquiry may not be generated. Thus, the net return under this scenario if V is not greater than C₁ may be −G. That is, the loss may be equal to the cost G of generating the memo since the dispute goes unchallenged and no revenue is collected. However, if V is greater than C₁, an inquiry may be generated. Since the audit amount is accurate, the inquiry is assumed to generate revenue equal to V, so that the net value produced if V>C₁ under this scenario is V−G−D.

Scenario 2: The agency debit memo is accurate, and the travel agency does not dispute the memo. As described above, the probability of this scenario may be A×(1−P_{R}). The net revenue recovered under this scenario may be equal to V−G. Because the travel agency does not dispute the agency debit memo under this scenario, an inquiry is not generated and the net revenue produced is the same regardless of the value of V. That is, the cost D of generating the inquiry does not affect the revenue recovered under this scenario.

Scenario 3: The agency debit memo is not accurate, and the travel agency disputes the memo. As described above, the probability of this scenario may be (1−A)×P_{W}. Similarly as described above with respect to scenario 1, the net revenue produced under this scenario may depend on whether the numerical discrepancy V is sufficiently large to trigger an inquiry in response to receiving the dispute. If V is not greater than C₁, the agency dispute may go unchallenged so that the cost of generating the inquiry is not incurred. The net value if V≦C₁ may therefore be −G, or a loss equal to the cost of generating the agency debit memo. If V is greater than C₁, an inquiry may be generated so that the total cost equals G+D. Because the audit amount is inaccurate, it may be assumed under this scenario that the inquiry will not generate any revenue due to the travel agency being absolved of any debit. The net value produced if V>C₁ under this scenario may therefore be −(G+D).

Scenario 4: The agency debit memo is inaccurate, and the travel agency does not dispute the memo. The probability of this scenario may be equal to (1−A)×(1−P_{W}), and the net revenue produced under this scenario may be equal to V−G. Because the travel agency does not dispute the agency debit memo under this scenario, an inquiry is not generated and the net revenue produced may be the same regardless of the value of V. That is, as with scenario 2, the cost D of generating the inquiry does not affect the revenue recovered.

The expected value of generating the agency debit memo may be determined by summing the product of the expected net value of each scenario times the probability that the scenario occurs. Because scenarios 1 and 3 have different expected values depending on whether an inquiry is generated in response to the dispute, two expected values may be determined. One of these two expected values may be based on an assumption that an inquiry is generated in response to receiving a dispute, and another of these two expected values may be determined based on an assumption that an inquiry is not generated in response to receiving a dispute. Assuming that an inquiry is performed, the expected value may be provided by the following equation:

[(A×P_{R})×(V−G−D)]+[(A×(1−P_{R})×(V−G)]+[1−A)×P_{W}×(−G−D)]+[(1−A)×(1−P_{W})×(V−G)] (Equation 3)

which may be simplified to yield:

V×(1−P_{W}×(1−A))−G−D×(P_{W}×(1−A)+A×P_{R}) (Equation 4)

Assuming that an agency debit memo is only generated if the expected value of the agency debit memo is positive, and solving Equation 4 for V yields:

$${V}_{1} = \frac{G + D \times ( {P}_{W} \times ( 1 - A ) + A \times {P}_{R} )}{1 - {P}_{W} \times ( 1 - A )} \qquad ( Equation 5 )$$

Thus, for scenarios that include generating an inquiry, the value of the numerical discrepancy V required to provide a positive expected value of generating the agency debit memo is V₁. Thus, the agency debit memo should not be generated for a scenario that includes generating an inquiry unless V≧V₁.

For scenarios in which an inquiry is not performed, the expected value of generating the agency debit memo may be provided by the following equation:

V×(A×(1−P_{R})+(1−A)×(1−P_{W}))−G (Equation 6)

Solving Equation 6 for V yields:

$${V}_{2} = \frac{G}{( A \times ( 1 - {P}_{R} ) + ( 1 - A ) \times ( 1 - {P}_{W} )} \qquad ( Equation 7 )$$

which may be simplified to yield Equation 1. Thus, for scenarios that do not include generating an inquiry, the value of the numerical discrepancy V required to provide a positive expected value of generating the agency debit memo is V₂. Thus, the agency debit memo should not be generated for a scenario that does not include generating an inquiry unless V≧V₂.

Because the cost of generating the inquiry may be substantially larger than the cost of generating the agency debit memo, the value of V required to justify generating the agency debit memo may depend largely on the probability that the agency debit memo will be disputed. As an extreme example, if the total probability that the travel agency will dispute the agency debit memo (A×P_{R}+(1−A)×P_{W}) is unity, then an agency debit memo would only be issued for an audit returning a numerical discrepancy V greater than V₁. Similarly, if the total probability that the travel agency will dispute the agency debit memo is zero, then an agency debit memo would be issued for any audit returning a numerical discrepancy V greater than V₂.

Assuming that: (1) the cost of generating the inquiry is substantially larger than the cost of generating the agency debit memo, and (2) the total probability that the travel agency disputes the agency debit memo is less than 0.5 may allow the further assumption:

$$\frac{G}{D } < A \times ( 1 - {P}_{R} ) \qquad ( Equation 8 )$$

which may imply:

$$\frac{G}{D} < A \times ( 1 - {P}_{R} ) \times \frac{A \times {P}_{R} + ( 1 - A ) \times {P}_{W}}{A \times {P}_{R}} \qquad ( Equation 9 )$$

Equation 9 may further imply:

$$\frac{G}{D} < [ ( A \times ( 1 - {P}_{R} ) + ( 1 - A ) \times ( 1 - {P}_{W} ) ] \times \frac{A \times {P}_{R} + ( 1 - A ) \times {P}_{W}}{A \times {P}_{R}} \qquad ( Equation 10 )$$

Equation 10 suggests that by assuming D>>G and (A×P_{R}+(1−A)×P_{W})<0.5, it may be further assumed that V₁≧V₂.

Because V₁≧V₂, it follows that there may exist some V having a value such that V₁≧V≧V₂. For a numerical discrepancy V≦V₂, an agency debit memo may not be generated because the expected value of generating the agency debit memo is at best zero. On the other hand, agency debit memos may be generated for values of V between V₁ and V₂, but if a dispute of the agency debit memos is received, an inquiry may not be generated. That is, if a dispute is received, the attempt to recover the numerical discrepancy may be abandoned without generating an inquiry. For the case where V≧V₁, an assumption is that:

$$\frac{G}{D} < \frac{\begin{matrix}( A \times {P}_{R} + ( 1 - A ) \times {P}_{W} ) \times \\ ( 1 - A \times {P}_{R} - ( 1 - A ) \times {P}_{W} )\end{matrix}}{A \times {P}_{R}} \qquad ( Equation 11 )$$

Setting (1−A)×P_{W}=x yields:

$$\frac{G}{D} < F ( x ) = \frac{( A \times {P}_{R} + x ) \times ( 1 - A \times {P}_{R} - x )}{A \times {P}_{R}} \qquad ( Equation 12 )$$

Under the existing assumption that the total probability that the agency debit memo will be disputed is less than 0.5, x₀ id defined as:

$${x}_{0} = \frac{1}{2} - A \times {P}_{R} \qquad ( Equation 13 )$$

Substituting into equation 12 yields:

$$\begin{matrix}F ( 0 ) = ( 1 - A \times {P}_{R} ) \\ and & ( Equation 14 ) \\ F ( {x}_{0} ) = \frac{1}{4 \times ( A \times {P}_{R} )} & ( Equation 15 )\end{matrix}$$

Thus, for x increasing from 0 to x₀, it is sufficient that:

$$\frac{G}{D} < A \times ( 1 - {P}_{R} ) < 1 - A \times {P}_{R} = F ( 0 ) \qquad ( Equation 16 )$$

to support the assertion that, for V>V₁, an inquiry should be performed in response to receiving a dispute.

In an embodiment of the invention, operators may execute tasks of generating agency debit memos and inquiries. To this end, the audit process management system 50 may be configured assign tasks to an operator from the unscheduled task list. The assigned task may be transmitted to the operator system 18 corresponding to the selected operator so that the operator may execute the task. The operator systems 18 may be configured to display received tasks to respective operators, and to accept input from the operators to execute the tasks. To optimize task scheduling and assignment, the optimizer module 54 may be configured to rank tasks in a desired order of execution based on a concept known as benefit density. The benefit density of a task may be the expected value of the task divided by the amount of time expected to complete the task, or the expected task execution time. The benefit density is therefore essentially a measure of the return on investment for the time an operator must spend on the task.

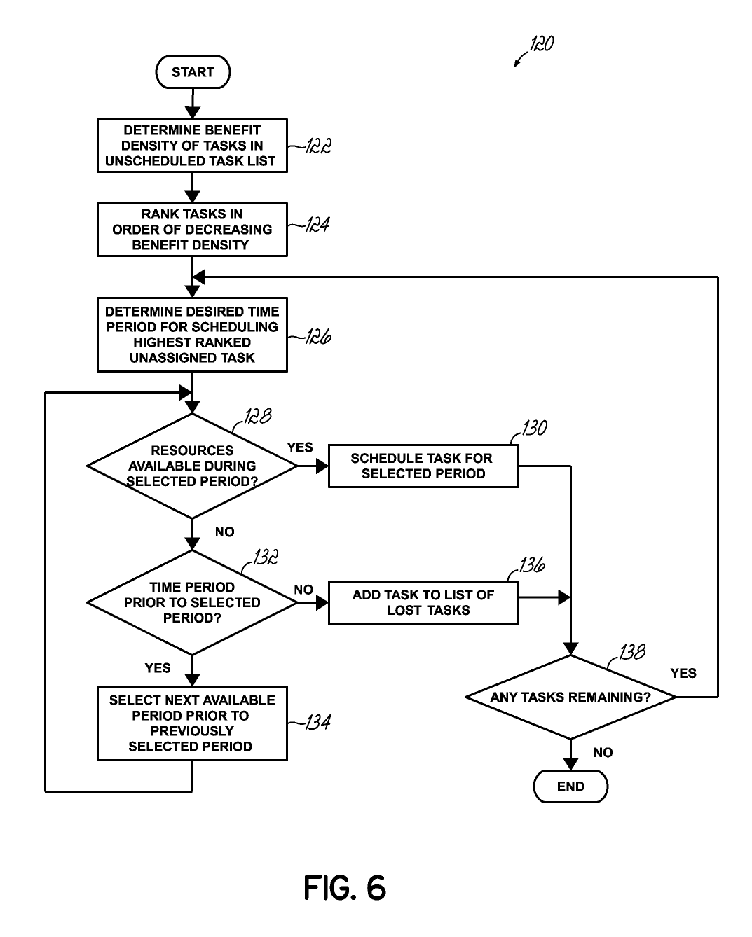

Referring now to FIG. 6, a flow chart is presented that depicts a task scheduling process 120 which may be performed by the optimizer module 54 in accordance with an embodiment of the invention. In block 122, the optimizer module 54 may determine a benefit density for each task in the unscheduled task list. The benefit density may be determined by dividing the expected value of executing the task (e.g., the expected value of generating the agency debit memo) by an estimated execution time (e.g., the estimated amount of time it would take an operator to execute the task). The optimizer module 54 may then proceed to block 124 and rank the tasks in the unscheduled task list in order of decreasing benefit density. Thus, the task list may be viewed a stack comprising tasks sorted by benefit density so that the task having the lowest benefit density is at the bottom of the stack, and the task having the highest benefit density is at the top of the stack.

In block 126, the optimizer module 54 may select a task from the top of the stack (i.e., the task having the highest benefit density in the unscheduled task list) and determine a desired or target time period for scheduling the task. This target time period may be related to a deadline by which the task must be executed. For example, business rules may require that agency debit memos and/or inquiries be generated within a certain amount of time from when the ticket was used or from receipt of a dispute. Agency debit memos and/or inquiries generated after this deadline may be invalid, so tasks should either be scheduled before the deadline or abandoned. To provide a margin of error for executing tasks, the target time period may be defined as being predetermined number of time periods (e.g., days) prior to the time period (e.g., day) on which the deadline occurs. By way of example, if the task deadline is on the 20th of the month, the target time period may be set five days prior to the deadline, or on the 15th of the month.

Once the target time period has been determined, the optimizer module 54 may attempt to schedule the task on the target period by proceeding to block 128. In block 128, the optimizer module 54 may determine if there are sufficient resources available to execute the task during the selected time period. This determination may be based on operator staffing levels, the other tasks currently scheduled for the selected time period, and the expected execution time for the task being scheduled. In response to determining that there are sufficient resources available to execute the task during the selected time period (“YES” branch of decision block 128), the optimizer module 54 may proceed to block 130 and schedule the task in the selected time period. In response to determining that there are not sufficient resources available to execute the task during the selected time period (“NO” branch of decision block 128), the optimizer module 54 may proceed to block 132.

In block 132, the optimizer module 54 may determine if a time period exits prior to the target time period. That is, the optimizer module 54 may determine if there is a time period between the present time and the previously selected time period. In response to there being a prior time period (“YES” branch of decision block 132), the optimizer module 54 may proceed to block 134 and select the prior time period before returning to block 128. In an embodiment of the invention, the prior time period may be the time period immediately prior to the previously selected time period. In response to a prior time period not being available (“NO” branch of decision block 132), the optimizer module 54 may proceed to block 136 and add the task to a lost task list that serves as a repository for tasks that could not be scheduled.

In any case, after the optimizer module 54 has either scheduled the task in block 130, or added the task to the lost task list in block 136, the optimizer module 54 may proceed to block 138. In block 138, the optimizer module 54 determines if there are any tasks remaining the unscheduled task list that have not been scheduled or added to the lost task list. In response to there being tasks remaining in the unscheduled task list (“YES” branch of decision block 138), the optimizer module 54 may return to block 126 to schedule the next task in the unscheduled task list. In response to no tasks remaining in the unscheduled task list, the optimizer module 54 may end the process and/or wait until tasks are added to the unscheduled task list.

The task scheduling process 120 may thereby define a scheduled task list that is organized into a plurality of subsets, with each subset being associated with a time period. Each subset may be sorted in descending order by benefit density to form a stack of tasks that are scheduled for the time period in question, with the task having the highest benefit density on top. By way of example, each time period may be a day on which operators are scheduled to work, and may be associated with the subset of tasks that are scheduled to be executed on that day.

The task scheduling process 120 may be repeated periodically so that as new tasks are generated and old tasks are executed, the scheduled task list is re-optimized to maximize the value of available resources. To this end, the task scheduling process 120 may be performed periodically, such as once a day. For example, the task scheduling process 120 may be performed as a nightly batch process executed during non-business hours so that the task sub-list for the next day is ready to be executed. The task scheduling process 120 may also be triggered: (1) each time a new task is generated and/or added to the unscheduled task list; (2) each time a task is executed and thus permanently removed from the scheduled task list; (3) each time a task is assigned to an operator; and (4) whenever an unexecuted task is returned to either the scheduled or the unscheduled task list due to an operator signing out of their operator system 18.

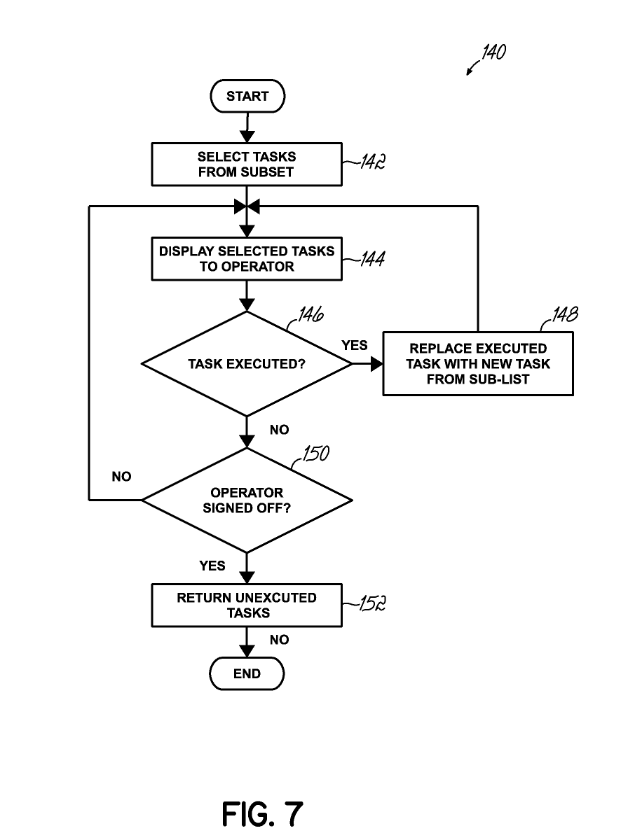

Referring now to FIG. 7, a flow chart depicts a task assignment process 140 for managing operator workflow that may be executed by the optimizer module 54. In block 142, one or more tasks (e.g., two tasks) having the highest benefit density may be selected from the subset associated with the current time period. The selection may occur in response to receiving an indication that an operator has become available. An operator may be indicated as available in response to the operator logging onto the operator system 18, or in response to the operator completing execution of an assigned task. Selected tasks may be removed from the subset, or otherwise marked as unavailable, so that a task is only assigned to one operator at a time. In block 144, the selected tasks may be displayed to the operator so that the operator may select a task from the displayed tasks.

In block 146, the optimizer module 54 may determine if the task selected by the operator has been executed. In response to the task being executed (“YES” branch of decision block 146), the optimizer module 54 may proceed to block 148 and select the next task from the top of the subset to replace the executed task. In this way, executed tasks may be replaced with a new task having the greatest task benefit density, which may optimize the value of the operators.

In block 150, the optimizer module 54 may determine if the operator has signed off. In response to a determination that the operator has not signed off (“NO” branch of decision block 150), the optimizer module 54 may return to block 144 and continue to display the selected tasks to the operator. In response to a determination that the operator has signed off (“YES” branch of decision block 150), the optimizer module 54 may proceed to block 152. In block 152, any unexecuted tasks that were selected for display to the operator may be returned to the subset of the scheduled task list, or otherwise marked as available, so that the tasks may be assigned to another operator. In an embodiment of the invention, if all the tasks in a subset are executed before the end of the time period (e.g., before the end of the day), tasks may be assigned to operators from the subset of the scheduled task list associated with the next time period. If all the tasks in the set are not executed by the end of the time period, then these unexecuted tasks may be returned to the unscheduled task list to be re-scheduled by the task scheduling process 120.

The data collection module 56 may be configured to monitor the task value estimating process 90, the task scheduling process 120, and the task assignment process 140. This monitoring may include collecting data relating to the accuracy of the audit engine, which agency debit memos are disputed, the cost and revenue returned by each agency debit memo, the results and costs of inquiries, and the time operators spend on each task. Collected data may be associated with an operator so that operator performance may be based on the results obtained by that operator. Monitoring the outcomes based on the operator that executed the underlying task may be used to provide an objective measure of operator performance. These objective measures of operator performance may be based on the net value realized for tasks executed by the operator. The objective measures may in turn facilitate taking remedial actions and/or identifying areas in need of improvement. The collected data may also be used to verify the parameters regarding probabilities, costs, and expected outcomes used to configure the optimizer module 54 are accurate, and to adjust the parameters in cases where they are inaccurate.

In order to attribute the value generated by a task to the operator who generated the task, the total value generated by auditing the ticket may be split between the tasks of generating the agency debit memo and generating the inquiry (if applicable). To this end, in an embodiment of the invention, for a numerical discrepancy V≧V₂, the value V_{ADM} attributed to generation of the agency debit memo may be provided by:

V_{ADM}=−G+V×(1−(A×P_{R}+(1−A)×P_{W})) (Equation 17)

Because an inquiry is not generated for a numerical discrepancy V of less than V₁, it may not be necessary to attribute a value to an inquiry for V having a value such that V₁≧V≧V₂. However, for V≧V₁, a value V_{INQ} attributed to generation of the inquiry may be provided by:

V_{INQ}=−D×(A×P_{R}+(1−A)×P_{W})+V×A×P_{R} (Equation 18)

One operator may have a lower efficiency than another operator for reasons that include: (1) the inefficient operator takes more time to perform a given task than the more efficient operator; and (2) the inefficient operator generates agency debit memos and/or inquiries of a lower quality. Lower quality agency debit memos may reduce the expected value of generating the agency debit memo by: (1) increasing the amount of time that must be spent following up on generation of the agency debit memo and/or inquiry; (2) reducing the value ultimately recovered (e.g., the requested amount was less than what should have been requested); and (3) a substandard agency debit memo may increase the chances that the travel agency will dispute the memo, resulting in increased costs for generating the inquiry and/or loss of the numerical difference V altogether.

Time and quality may therefore impact the net value of generating an agency debit memo. Thus, a memo may have a different expected value depending on the operator that is generating the memo. By enabling task net value creation to be tracked on an operator-by-operator basis, the audit process management system 50 may facilitate managing operator efficiency. For example, inefficient operators may be identified based on the value generated by the agency debit memos and inquiries they generate. These inefficient operators may then be remediated through additional training or replacement if the operator continues to fail to meet objectives. Data indicative of operator efficiency ratings may also be received at the parameter update module 58 and used to adjust the estimates for the expected values of generating agency debit memos and/or inquiries.

In an embodiment of the invention, the decision whether to generate an agency debit memo and/or an inquiry may be determined based on the relation between the numerical discrepancy V and values of the expected costs C₀, C₁ provided by Equations 1 and 2. To this end, the data collection and parameter update modules 56, 58 may be configured to: (1) determine an actual unit cost per type of task and compare the actual unit costs to the estimated cost G of generating the agency debit memo and the estimated cost D of generating an inquiry in response to the agency debit memo being disputed; (2) determine an actual percentage of agency debit memos that are disputed, and compare these percentages to the total probability that the travel agency will dispute the agency debit memo (A×P_{R}+(1−A)×P_{W}); and (3) determine the percentage of disputed agency debit memos in which the audit amount was correct, which may be compared to the probability the agency debit memo is accurate and the travel agency disputes the memo (A×P_{R}). These parameters may be determined empirically based on the historical data obtained by the data collection module 56, and updated by the parameter update module 58. Moreover, the parameters may be determined individually by type of ticket sold (e.g., by city pair, fare, type of travel, airline, etc.) so that estimated costs, audit accuracies, and probabilities may be determined based on the type of ticket.

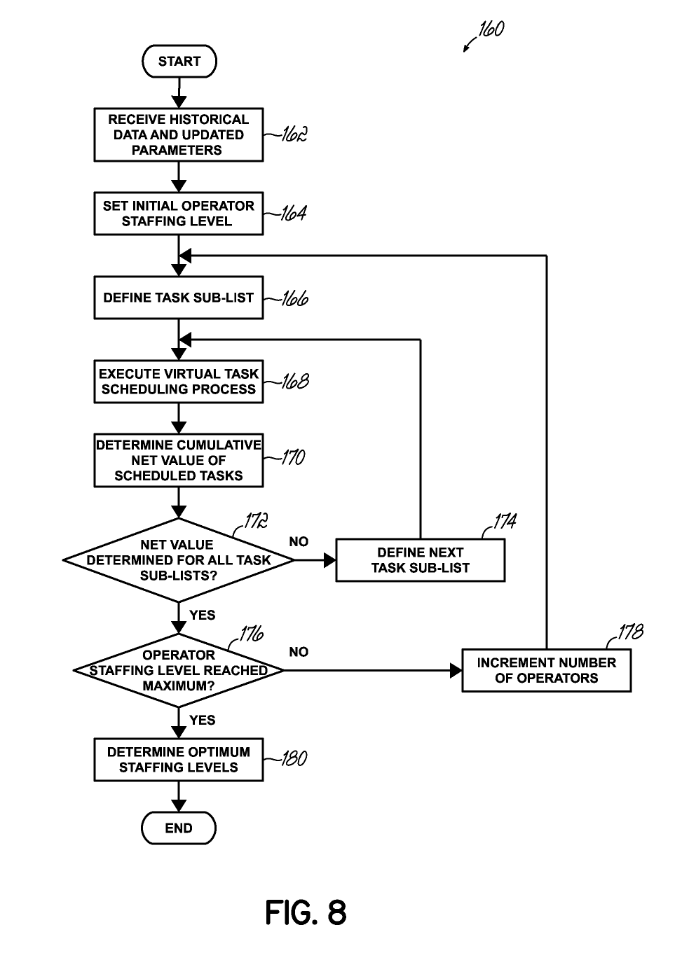

Referring now to FIG. 8, a flow chart is presented that depicts a resource estimation process 160 for determining an optimum operator staffing level. The resource estimation process 160 may be executed by the estimator module 60, which may essentially execute the task scheduling process 120 of optimizer module 54 in a virtual way to determine the effects of different operator staffing levels. The estimator module 60 may use the updated parameter data so that recommended staffing levels reflect the latest results. In block 162, the estimator module 60 may receive historical data relating to the results of the audit process and the updated parameters for a plurality of previously audited tickets. The historical data may include cost and value data regarding generation of agency debit memos and inquiries, the frequency that agency debit memos were disputed, and whether inquiries were generated in response to the disputes. Updated parameters may include estimated generation costs, audit engine accuracy, and probabilities that agency debit memos will be disputed. The estimator module 60 may then proceed to block 164 and set an initial operator staffing level (e.g., one operator) before proceeding to block 166.

For previous tasks that were actually scheduled and executed, the estimator module 60 may use the historical data regarding the actual outcome of generating agency debit memos and/or inquiries to determine the expected values of executing the tasks. That is, the “expected” values for previously scheduled tasks may be known. However, for tasks that were not scheduled (e.g., due to a lack of resources), there may be uncertainty regarding whether a generated memo would have been disputed. That is, the estimator module 60 may need to determine if an agency debit memo should be generated, and whether an inquiry should be generated in response to receiving a dispute by determining expected values as describe above. However, because historical data may not be available regarding the actual outcome, this may produce a level of uncertainty regarding whether the travel agency would have disputed the memo, as well as the outcome had the inquiry been generated.

In block 166, the estimator module 60 may address this uncertainty by defining a task sub-list based on an assumption regarding whether travel agencies would have disputed agency debit memos had they been generated. The task sub-list may be one of a plurality of task sub-lists, and may be defined based on a best-case scenario that assumes that all new agency debit memos generated would not have been disputed by the travel agency had the memo actually been generated. Under this best case scenario, no inquiries may be necessary other than those that were actually generated. Thus, the best case scenario sub-task list may not include any new inquiry generation tasks that were not generated during the historical time period being analyzed.

Another task sub-list may be based on a worst-case scenario which assumes that any new agency debit memo generated during the resource estimation process 160 would have been disputed by the corresponding travel agency. Thus, the worse-case scenario task sub-list may: (1) include inquiry tasks corresponding to each newly scheduled agency debit memo task that has a numerical value V≧V₁; and (2) assume no return on newly scheduled agency debit memo tasks for V having a value such that V₁≧V≧V₂. Persons having ordinary skill in the art will understand that other task sub-lists may also be defined and analyzed. For example, a task sub-list may be defined that includes inquiry tasks for only a portion of the newly generated agency debit memos. The memos disputed may be selected based on the probabilities P_{R}, P_{W}, and A. A task sub-list may also be generated based on a weighted average of the best-case and worst-case sub-lists.

In block 168, the estimator module 60 may execute a virtual task scheduling process similar to the task scheduling process 120 depicted in FIG. 6. To this end, the virtual task scheduling process may execute the task scheduling process 120 using an unscheduled task list that includes the task sub-list generated in block 166. The virtual task scheduling process may thereby execute a virtual process or simulation to determine what tasks can be scheduled for the given operator staffing level without actually assigning the tasks to operators. To this end, the estimator module 60 may execute the virtual task scheduling process independently, or may rely on the optimizer module 54 to execute all or a portion of the virtual task scheduling process. In any case, in response to completion of the virtual task scheduling process, the estimator module 60 may proceed to block 170 and determine a cumulative net value for all tasks scheduled by the virtual task scheduling process of block 168.

In block 172, if the cumulative net value has not been determined for all task sub-lists being analyzed (“NO” branch of decision block 172), the estimator module 60 may proceed to block 174 and define the next task sub-list. The estimator module 60 may then return to block 168 to execute the virtual task scheduling process for the new task sub-list. If a net value has been determined for all the task sub-lists being analyzed (“YES” branch of decision block 172), the estimator module 60 may proceed to block 176.

In block 176, the estimator module 60 may determine if the operator staffing levels being used in the virtual task scheduling process has reached a maximum level that is to be evaluated. The maximum level may be selected to provide a staffing level at which the total net value determined in block 170 is less than a previous level determined for a lower staffing level. In response to the staffing level not having reached the maximum level (“NO” branch of decision block 176), the estimator module 60 may proceed to block 178 and increment the number of operators before returning to block 166. The estimator module 60 may thereby repeat the process of determining cumulative net value estimates for a plurality of staffing levels. In response to the operator staffing level having reached the maximum level (“YES” branch of decision block 176), the estimator module 60 may proceed to block 180.

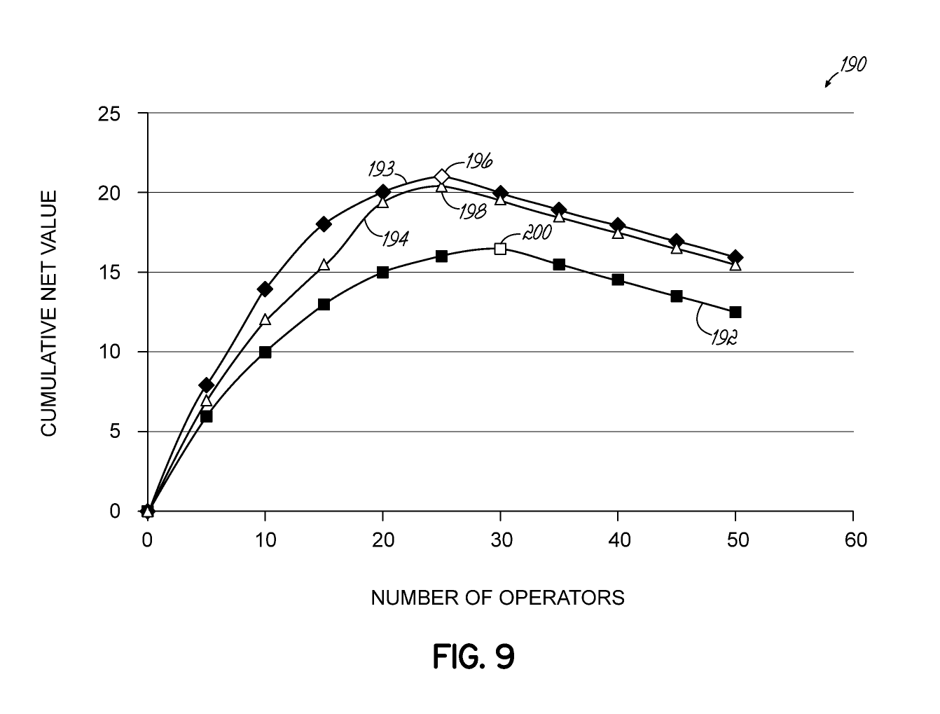

In block 180, the estimator module 60 may determine one or more estimated optimum staffing levels. Referring to FIG. 9, an exemplary graph 190 includes a plurality of plots 192-194 of cumulative net value verses operator staffing level. Each plot 192-194 may represent a plurality of cumulative net values for a particular sub-list, with each cumulative net value having been determined by the estimator module 60 as a function of a corresponding staffing level for that sub-list. The staffing level may be varied between a minimum number of operators (e.g., 0 operators) and the maximum number of operators (e.g., 50 operators) for each of a plurality of task sub-lists. The minimum and maximum number of operators may be selected arbitrarily, or may reflect estimated staffing levels required to handle best case and worst-case scenarios. The minimum and maximum operator staffing levels may also include an additional number of operators needed to provide a safety margin sufficient to handle expected peak load levels.

In the exemplary embodiment depicted, plot 192 may represent the estimated cumulative net values for the worst-case scenario described above, plot 193 may represent the estimated cumulative net values for the best-case scenario described above, and plot 194 may represent the estimated cumulative net values for a predicted scenario that falls between the worst-case and best-case scenarios. For example, plot 194 may represent operator staffing levels based on an expected probability that generated agency debit memos would be disputed by the corresponding travel agency. Plot 194 may thus represent an expected or approximate set of results based on a weighted combination of the best-case and worst-case scenarios, with the weighing being determined based on the total probability that the travel agency will dispute the agency debit memo.

As can be seen from plots 193 and 194, the estimated operator staffing level that generates respective maximum cumulative net values for the best-case and predicted case scenarios in the exemplary graph 190 is 25 operators, as indicated by plot maximums 196, 198. The location of the maximums 196, 198 may indicate that: (1) the expected value of the additional tasks that would be scheduled by having an operator staff greater than 25 would be less than the cost of the additional operators; and (2) the expected value of tasks that would be left unscheduled by having an operator staff of less than 25 would be greater than the cost of the additional operators. Similarly, a maximum 200 for the worst-case scenario plot 192 may indicate that an operator staffing level of 30 would provide the highest cumulative net value for the worst-case scenario. This result may further indicate that scenarios having a higher number of disputed agency debit memos may not only require higher operator staffing levels, but may provide lower levels of cumulative net returns.

In each of the plots 192-194, the curves may have a decreasing slope as staffing levels increase because the tasks are added in order of decreasing benefit density. That is, the plots 192-194 may represent concave functions. Thus, the additional tasks that can be scheduled and executed due to an incremental increase in staffing levels may add less to the cumulative net value than added by the previous incremental increase in staffing levels. Each plot 192-194 may reach their respective maximums 196, 198, 200 at a point at which there are sufficient resources to complete all tasks having a positive expected value. Because each task executed beyond that point may have a negative expected value, no additional value is created by adding additional resources beyond the number of operators that generates the maximum cumulative net value. The maximum 200 for the worst-case scenario may occur at a higher operator staffing level since more resources may be required to complete the additional tasks included in the worst-case task sub-list.

The program code embodying any of the embodiments of the invention described herein is capable of being individually or collectively distributed as a program product in a variety of different forms. In particular, the program code may be distributed using a computer readable media, which may include computer readable storage media and communication media. Computer readable storage media, which are inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Communication media may embody computer readable instructions, data structures, or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

The methods described herein can be implemented by computer program instructions supplied to the processor of any type of computer to produce a machine with a processor that executes the instructions to implement the functions/acts specified herein. These computer program instructions may also be stored in a computer readable medium that can direct a computer to function in a particular manner. To that end, the computer program instructions may be loaded onto a computer to cause the performance of a series of operational steps and thereby produce a computer implemented process such that the executed instructions provide processes for implementing the functions/acts specified herein.

In addition, program code described herein may be identified based upon the application or software component within which the program code is implemented in a specific embodiment of the invention. However, it should be appreciated that any particular program nomenclature that follows is used merely for convenience, and thus the invention should not be limited to use solely in any specific application identified and/or implied by such nomenclature. It should be further appreciated that the various features, applications, and devices disclosed herein may also be used alone or in any combination. Moreover, given the typically endless number of manners in which computer programs may be organized into routines, procedures, methods, modules, objects, and the like, as well as the various manners in which program functionality may be allocated among various software layers that are resident within a typical computing system (e.g., operating systems, libraries, APIs, applications, applets, etc.), and/or across one or more hardware platforms, it should be appreciated that the invention is not limited to the specific organization and allocation of program functionality described herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising.”

While embodiments of the invention have been illustrated by a description of various examples, and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative methods, and illustrative examples shown and described. Accordingly, departures may be made from such details without departing from the spirit or scope of applicant's general inventive concept.

1. A method of issuing an agency debit memo to a travel agency, the method comprising:
receiving, at a computer, data relating to a ticket sold by the travel agency;
auditing, at the computer, the ticket based on the data to compare a first amount charged for the ticket with a second amount that is an audit amount for the ticket;
in response to the second amount exceeding the first amount by a numerical discrepancy, determining a first expected value of generating the agency debit memo based on a first cost model in which an inquiry regarding an accuracy of the agency debit memo is not generated in response to a dispute of the agency debit memo by the travel agency; and
generating the agency debit memo if the first expected value is greater than a first threshold value.

2. The method of claim 1 further comprising:
determining a second expected value of generating the agency debit memo based on a second cost model in which the inquiry regarding the accuracy of the agency debit memo is generated in response to the dispute of the agency debit memo by the travel agency; and
generating the inquiry in response to the dispute if the second expected value is greater than a second threshold value.

3. The method of claim 2 wherein the first and second threshold values are zero.

4. The method of claim 2 wherein determining the second expected value of generating the agency debit memo comprises:
determining a first cost of generating the agency debit memo;
determining a second cost of generating the inquiry;
determining a first probability that the travel agency will dispute the agency debit memo;
determining a second probability that the agency debit memo will be inaccurate and the travel agency will dispute the inaccurate agency debit memo;
determining a third probability equal to unity minus the second probability;
determining a first product by multiplying the third probability by the numerical discrepancy;
determining a second product by multiplying the first probability by the second cost; and
subtracting the first cost and the second product from the first product to produce the second expected value.

5. The method of claim 4 wherein determining the first probability comprises:
determining a fourth probability that the auditing of the ticket is accurate;
determining a fifth probability that the auditing of the ticket is inaccurate;
determining a sixth probability that the travel agency will dispute the agency debit memo if auditing of the ticket is accurate;
determining a seventh probability that the travel agency will dispute the agency debit memo if the auditing of the ticket is inaccurate;
determining a third product by multiplying the fourth probability by the sixth probability;
determining a fourth product by multiplying the fifth probability by the seventh probability; and
summing the third and fourth products to produce the first probability.

6. The method of claim 5 wherein the fifth probability is determined by subtracting the fourth probability from unity.

7. The method of claim 1 wherein auditing the ticket based on the data comprises:
determining the second amount by applying business rules to the received data to determine a fare for the ticket.

8. The method of claim 1 wherein determining the first expected value of generating the agency debit memo comprises:
determining an estimated cost to generate the agency debit memo;
determining a probability that the travel agency will not dispute the agency debit memo;
determining an expected return on generation of the agency debit memo by multiplying the numerical discrepancy by the probability; and
subtracting the estimated cost from the expected return to produce the first expected value.

9. An apparatus comprising:
a processor; and
a memory including instructions that, when executed by the processor, cause the apparatus to:
receive data relating to a ticket sold by a travel agency;
audit the ticket based on the data to compare a first amount charged for the ticket with a second amount that is an audit amount for the ticket;
in response to the second amount exceeding the first amount by a numerical discrepancy, determine a first expected value of generating an agency debit memo based on a first cost model in which an inquiry regarding an accuracy of the agency debit memo is not generated in response to a dispute of the agency debit memo by the travel agency; and
generate the agency debit memo if the first expected value is greater than a first threshold value.

10. A computer program product comprising:
a non-transitory computer readable storage medium; and
instructions stored on the non-transitory computer readable storage medium that, when executed by a processor, cause the processor to:
receive data relating to a ticket sold by a travel agency;
audit the ticket based on the data to compare a first amount charged for the ticket with a second amount that is an audit amount for the ticket;
in response to the second amount exceeding the first amount by a numerical discrepancy, determine a first expected value of generating an agency debit memo based on a first cost model in which an inquiry regarding an accuracy of the agency debit memo is not generated in response to a dispute of the agency debit memo by the travel agency; and
generate the agency debit memo if the first expected value is greater than a first threshold value.

11-27. (canceled)

28. The apparatus of claim 9 wherein the instructions further cause the apparatus to:
determine a second expected value of generating the agency debit memo based on a second cost model in which the inquiry regarding the accuracy of the agency debit memo is generated in response to the dispute of the agency debit memo by the travel agency; and
generate the inquiry in response to the dispute if the second expected value is greater than a second threshold value.

29. The apparatus of claim 28 wherein the instructions that cause the apparatus to determine the second expected value of generating the agency debit memo comprise instructions that cause the apparatus to:
determine a first cost of generating the agency debit memo;
determine a second cost of generating the inquiry;
determine a first probability that the travel agency will dispute the agency debit memo;
determine a second probability that the agency debit memo will be inaccurate and the travel agency will dispute the inaccurate agency debit memo;
determine a third probability equal to unity minus the second probability;
determine a first product by multiplying the third probability by the numerical discrepancy;
determine a second product by multiplying the first probability by the second cost; and
subtract the first cost and the second product from the first product to produce the second expected value.

30. The apparatus of claim 29 wherein the instructions that cause the apparatus to determine the first probability comprise instructions that cause the apparatus to:
determine a fourth probability that the auditing of the ticket is accurate;
determine a fifth probability that the auditing of the ticket is inaccurate;
determine a sixth probability that the travel agency will dispute the agency debit memo if auditing of the ticket is accurate;
determine a seventh probability that the travel agency will dispute the agency debit memo if the auditing of the ticket is inaccurate;
determine a third product by multiplying the fourth probability by the sixth probability;
determine a fourth product by multiplying the fifth probability by the seventh probability; and
sum the third and fourth products to produce the first probability.

31. The apparatus of claim 30 wherein the fifth probability is determined by subtracting the fourth probability from unity.

32. The apparatus of claim 9 wherein the instructions that cause the apparatus to audit the ticket based on the data comprise instructions that cause the apparatus to:
determine the second amount by applying business rules to the received data to determine a fare for the ticket.

33. The apparatus of claim 9 wherein the instructions that cause the apparatus to determine the first expected value of generating the agency debit memo comprise instructions that cause the apparatus to:
determine an estimated cost to generate the agency debit memo;
determine a probability that the travel agency will not dispute the agency debit memo;
determine an expected return on generation of the agency debit memo by multiplying the numerical discrepancy by the probability; and
subtract the estimated cost from the expected return to produce the first expected value.

34. The computer program product of claim 10 wherein the instructions stored on the non-transitory computer readable storage medium further cause the apparatus to:
determine a second expected value of generating the agency debit memo based on a second cost model in which the inquiry regarding the accuracy of the agency debit memo is generated in response to the dispute of the agency debit memo by the travel agency; and
generate the inquiry in response to the dispute if the second expected value is greater than a second threshold value.

35. The computer program product of claim 34 wherein the instructions stored on the non-transitory computer readable storage medium that cause the apparatus to determine the second expected value of generating the agency debit memo comprise instructions stored on the non-transitory computer readable storage medium that cause the apparatus to:
determine a first cost of generating the agency debit memo;
determine a second cost of generating the inquiry;
determine a first probability that the travel agency will dispute the agency debit memo;
determine a second probability that the agency debit memo will be inaccurate and the travel agency will dispute the inaccurate agency debit memo;
determine a third probability equal to unity minus the second probability;
determine a first product by multiplying the third probability by the numerical discrepancy;
determine a second product by multiplying the first probability by the second cost; and
subtract the first cost and the second product from the first product to produce the second expected value.

36. The computer program product of claim 35 wherein the instructions stored on the non-transitory computer readable storage medium that cause the apparatus to determine the first probability comprise instructions stored on the non-transitory computer readable storage medium that cause the apparatus to:
determine a fourth probability that the auditing of the ticket is accurate;
determine a fifth probability that the auditing of the ticket is inaccurate;
determine a sixth probability that the travel agency will dispute the agency debit memo if auditing of the ticket is accurate;
determine a seventh probability that the travel agency will dispute the agency debit memo if the auditing of the ticket is inaccurate;
determine a third product by multiplying the fourth probability by the sixth probability;
determine a fourth product by multiplying the fifth probability by the seventh probability; and
sum the third and fourth products to produce the first probability.

37. The computer program product of claim 36 wherein the fifth probability is determined by subtracting the fourth probability from unity.

38. The computer program product of claim 10 wherein the instructions stored on the non-transitory computer readable storage medium that cause the apparatus to audit the ticket based on the data comprise instructions stored on the non-transitory computer readable storage medium that cause the apparatus to:
determine the second amount by applying business rules to the received data to determine a fare for the ticket.

39. The computer program product of claim 10 wherein the instructions stored on the non-transitory computer readable storage medium that cause the apparatus to determine the first expected value of generating the agency debit memo comprise instructions stored on the non-transitory computer readable storage medium that cause the apparatus to:
determine an estimated cost to generate the agency debit memo;
determine a probability that the travel agency will not dispute the agency debit memo;
determine an expected return on generation of the agency debit memo by multiplying the numerical discrepancy by the probability; and
subtract the estimated cost from the expected return to produce the first expected value.
